(19) United States
(12) Patent Application Publication
(10) Pub. No.: US 2019/0208757 A1
(43) Pub. Date: Jul. 11, 2019

(54) JUG FISHING RIG WITH SIGNAL ASSEMBLY

(71) Applicant: Donald McZilkey, Madison, GA (US)

(72) Inventor: Donald McZilkey, Madison, GA (US)

(21) Appl. No.: 15/864,945

(22) Filed: Jan. 8, 2018

(51) Int. Cl. A01K 97/12; A01K 93/02; A01K 99/00; G01P 15/18

(52) U.S. Cl. CPC A01K 97/125; G01P 15/18; A01K 99/00; A01K 93/02

(57) ABSTRACT

Systems for deploying and monitoring fishing rigs are described. A jug fishing rig in various embodiments includes a float supporting tackle and a signal assembly. The signal assembly may include a lamp and an accelerometer for detecting movement of the float in response to a fish striking the tackle. When the detected movement exceeds a threshold acceleration, the lamp emits an alert such as a color change. The signal assembly may include a panel of programmable MEMS components, including a microprocessor. The panel may be attached to a disk that fits between the neck of the float and its cap, securely supporting the signal assembly inside the float.

### BACKGROUND

Certain disclosed embodiments relate to the field of fishing and, more particularly, to a fishing rig having a float and a signal assembly.

Jug fishing is a method of fishing that uses a fishing line and tackle suspended from a floating jug, commonly deployed to catch fish in ponds, lakes, or rivers. The user can bait and deploy a large set of jugs in an area. Empty soda bottles or milk jugs are often used, with the cap secured to prevent water intrusion and maintain flotation.

Unlike pole fishing, jugs do not require constant attention. When the user wants to check the set of jugs, several problems arise. First, the location of each jug may be unknown or difficult to determine visually, especially at night. Freely floating jugs typically drift or are carried by the water's current. Several hours may have passed. In addition, the ownership of each jug may be in question because, in popular or busy locations, several different users may have deployed their own set of jugs in the same area. Finally, of course, the user will want to know if a fish has been caught. Accurate and timely retrieval of a caught fish reduces the risk of loss and, once redeployed, makes the jug available for additional fishing.

When fishing with a set of plain jugs, nearly constant visual attention may be required in order to keep track of location of jugs and to see jug movements that indicate a fish has been caught. However, because jug fishing is usually intended to be a more relaxed and casual endeavor than pole fishing, the need to constantly watch a set of jugs can defeat the purpose. Some sets of jugs may include particular colors, handle shapes, markings, or other indicia to differentiate one set from another. Other jugs may include complicated electromechanical devices for sensing fish contact or broadcasting a signal.

Personalized or custom sets of fishing jugs are generally expensive and require too much variety to offer a useful solution for locating and identifying the user's particular set of jugs. Homemade markings are usually difficult to see and not sufficiently durable for harsh marine environments. Likewise, outfitting each jug with complex sensors or transmitters also adds expense and complexity to what should be a relaxing and enjoyable activity.

Thus, there is a need in the art for an improved fishing rig having a float and a signal assembly for jug fishing.

### SUMMARY

A fishing rig is described. According to particular embodiments, the fishing rig includes a float and a signal assembly. The float may have a neck portion defining an opening and a selectively releasable cap that is sized and shaped to engage with the opening, with the float supporting fishing tackle connected to at least one line. The signal assembly may include a disk sized and shaped to be secured between the opening and the cap, and a panel connected to the disk. The panel may support a power supply, an accelerometer, and a lamp, wherein the lamp emits an alert in response to a tilt signal produced when the accelerometer detects a movement of the float that exceeds a threshold acceleration.

The float may include a hollow container, in which the neck portion further defines a plurality of external threads, and the cap comprises a plurality of internal threads sized and shaped to releasably engage the plurality of external threads.

The fishing tackle may include at least one element selected from the group consisting of hooks, lines, leader lines, sinkers, rigs, weights, beads, floats, clevises, swivels, snaps, lures, spinners, and baits.

The power supply may include a battery supported by a battery holder.

The lamp may include a red-green-blue light-emitting diode (LED).

The panel may be oriented in a direction generally orthogonal with respect to the disk. The panel may be positioned inside the float when the disk is secured between the opening and the cap, and the cap may provide a generally water-resistant seal.

The signal assembly may further include a programmable microprocessor that is powered by the power supply and electrically connected to the accelerometer and the lamp. The microprocessor may be responsive to the tilt signal produced by the accelerometer in response to a movement. The microprocessor, in response to the tilt signal, may transmit an alert signal to the lamp. The alert produced by the lamp may include a change from a stable color to an alert color.

The microprocessor may be programmed by a user to select the stable color to be displayed when the fishing rig is generally at rest in the water, and to select the alert color to be displayed by the lamp in response to the alert signal.

The panel may include a printed circuit board on a generally planar substrate, the substrate having a top face and a generally opposing bottom face. The printed circuit board may be electrically connected the power source, the accelerometer, and the lamp, and the microprocessor. The accelerometer may include a digital, programmable, three-axis accelerometer. The power supply may include a battery supported on the bottom face by a battery holder.

Other apparatuses, methods, systems, features, and advantages of the disclosed embodiments will be apparent to one of ordinary skill in the art upon examination of the following figures and detailed description. All such additional apparatuses, methods, systems, features, and advantages are intended to be included within this description and to be included within the scope of the accompanying claims.

### BRIEF DESCRIPTION OF THE DRAWING

Features of the various embodiments disclosed will become more apparent in the following detailed description, in which reference is made to the appended drawing, wherein:

FIG. 1 is a perspective illustration of a signal assembly that includes a lamp supported by a panel that is connected to a disk, according to various embodiments.

FIG. 2 is a perspective illustration of a fishing rig attached to a float and a signal assembly oriented for insertion into the float, according to various embodiments.

FIG. 3 is a plan-view illustration of a signal assembly that includes a lamp and a disk, according to various embodiments.

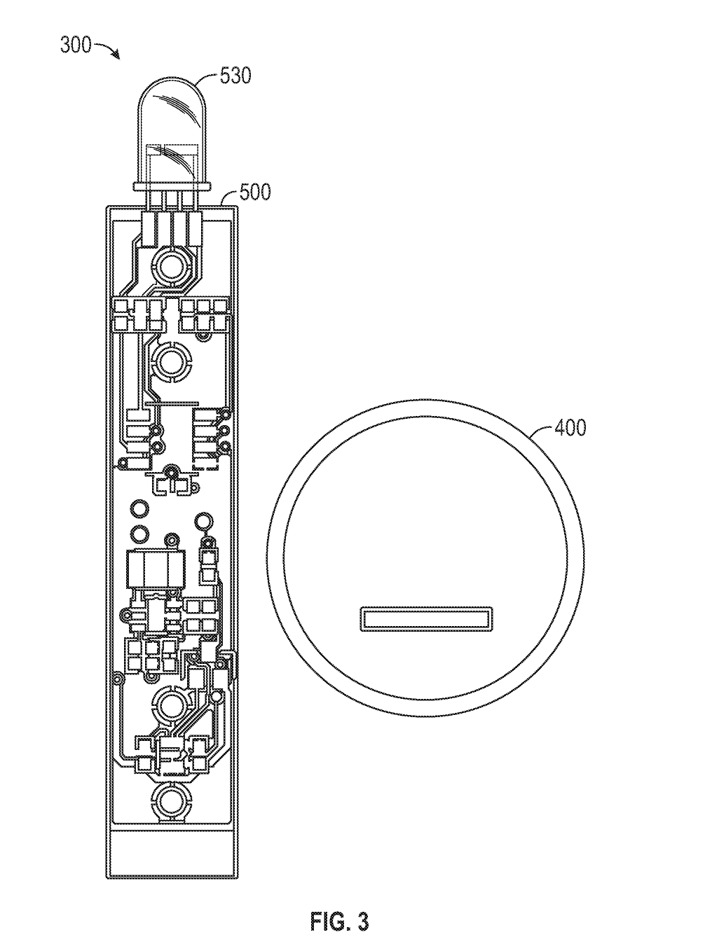

Corresponding reference numbers indicate corresponding parts or elements throughout the several views of the drawing.

### DETAILED DESCRIPTION

The present systems and apparatuses and methods are understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

Like parts are marked throughout the following description and drawings with the same reference numerals. The drawings may not be to scale and certain features may be shown exaggerated in scale or in somewhat schematic format in the interest of clarity, conciseness, and to convey information.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to a component can include two or more such components unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

As used herein, the term “facilitate” means to make easier or less difficult and the term “impede” means to interfere with, hinder, or delay the progress. Also, the words “proximal” and “distal” are used to describe items or portions of items that are situated closer to and away from, respectively, a user or operator. Thus, for example, the near end or other portion of an item may be referred to as the proximal end, whereas the generally opposing portion or far end (or free end) may be referred to as the distal end.

As used herein, the term “water-resistant” to describe an object or connection means it is capable of resisting the intrusion of water to a significant degree but not entirely, and does not mean strictly watertight or impermeable.

Although the various embodiments are described with reference to jug fishing, the assemblies and systems described herein may be used with any of a variety of activities the involve the remote monitoring of a set of containers or objects.

### Fishing Rig

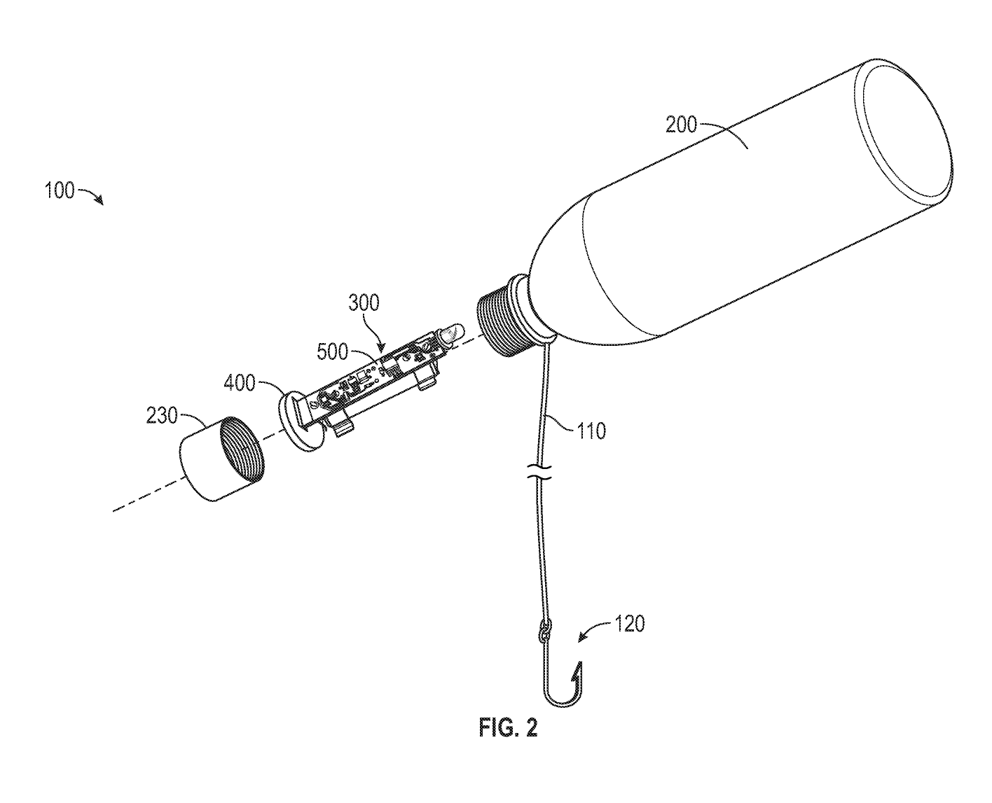

A fishing rig 100, according to various embodiments, includes a float 200 and a signal assembly 300, as shown in FIG. 2. The signal assembly 300 may include a lamp and an accelerometer for detecting movement of the float 200. When the detected movement exceeds a threshold acceleration, the lamp emits an alert, such as a change in color.

The float 200 may be an ordinary beverage bottle of any suitable size or it may be another hollow container that is well suited to jug fishing. The float 200, as shown in FIG. 2, may have a neck portion that defines an opening and a selectively releasable cap 230 that is sized and shaped to engage with the opening. Any hollow container may be used as a float 200. The float 200, according to various embodiments, comprises a hollow container with a neck portion that defines a plurality of external threads. The cap 230 includes a plurality of internal threads that are sized and shaped to releasably engage with the external threads on the neck portion.

The float 200 supports fishing tackle 120 that is connected to at least one fishing line 110. Any tackle 120 may be used, along with any number of fishing lines 110, according to the user's preference. The tackle 120 may include a single hook, as shown in FIG. 2; however, the tackle 120 may include one or more hooks, lines, leader lines, sinkers, rigs, weights, beads, floats, clevises, swivels, snaps, lures, spinners, baits, and the like.

The signal assembly 300 may include a disk 400 that is sized and shaped to be secured between the float opening and the releasable cap 230. In this aspect, the cap 230 holds the signal assembly 300 inside the float 200 when the cap 230 is secured tightly onto the float opening, thereby protecting the signal assembly 300 from the water, while also maintaining the signal assembly 300 in a direction that is generally aligned with the central axis of the float 200. The cap 230 and the neck opening of the float 200 provide a water-resistant seal that protects the disk 400 and signal assembly 300. As used herein, the term “water-resistant” means the seal is capable of resisting the intrusion of water to a significant degree but not entirely; the term does not mean strictly watertight or impermeable. For floats 200 of different sizes and shaped, the disk 400 may need to have a particular diameter so that it fits between the neck opening of the float 200 and within the interior diameter of the releasable cap 230. In this aspect, the size of the disk 400 may be matched to the particular size of the float 200 to be used as part of the fishing rig 100.

As shown in FIG. 2, the signal assembly 300 may include a panel 500 connected to the disk 400 by soldering or by another suitable connecting technique. As shown, the panel 500 is oriented in a direction generally orthogonal with respect to the disk 400. According to a particular embodiment, the disk 400 may be 1000 mil (1 inch) in diameter and the panel may be 400 mil by 2100 mil.

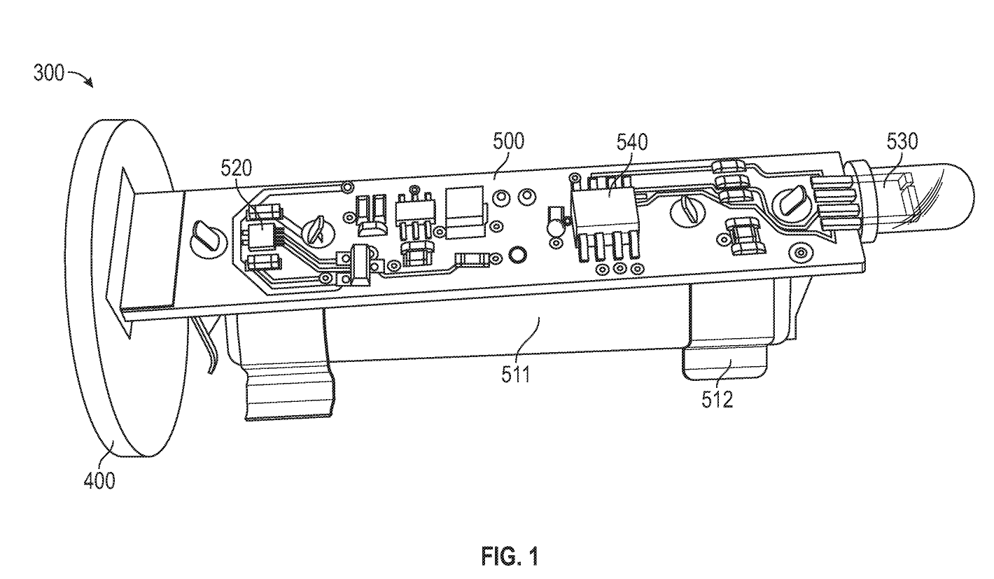

The panel 500, as shown in FIG. 1, may support an accelerometer 520, a lamp 530, and a power supply. The panel 500 may include a printed circuit board disposed on a substrate layer. The components disposed on the panel 500 may include miniaturized elements known as MEMS (Micro-Electro-Mechanical Systems) which are configured to interact with other components in a circuit. For example, the circuit may include one or more capacitors, transistors, and resistors, such as those available from commercial suppliers like DigiKey. As shown, the panel 500 may also support a microprocessor 540 that is programmable and accessible to the user who can create, modify, delete, and otherwise program the instructions for the circuits as desired.

The power supply for the signal assembly 300 may include a battery 511, such as a standard double-A battery, supported on the underside or bottom face of the panel 500 by a battery holder 512. The accelerometer 520 may be a digital, programmable, three-axis MEMS accelerometer. The lamp 530 may be a light-emitting diode (LED) configured to receive instructions from the microprocessor 540. For example, the lamp 530 may be a red-green-blue LED. The lamp 530 may be capable of emitting light in a variety of colors and in any of a variety of patterns (steady, flashing, intermittent flashing, and the like).

In use, as described herein, the microprocessor 540 and related elements may be programmed to send customized instructions to the lamp 530. The programming of the microprocessor 540, according to various embodiments, may include holding the signal assembly 300 in various orientations and for various time durations, to set or change the colors emitted, as described herein.

In use, as described herein, the microprocessor 540 and related elements may be programmed so that the lamp 530 emits an alert (such as a change in color and/or a change in pattern) in response to a tilt signal that is produced when the accelerometer 520 detects a movement of the float 200 that exceeds a threshold acceleration. The threshold acceleration, as used herein, means an acceleration (i.e., a change in linear velocity) that exceeds a certain limit. The accelerometer 520, according to various embodiments, may be configured to detect a change in orientation of the signal assembly 300, in much the same way that an accelerometer in a smartphone detects how the device is being held. In this aspect, the tilt signal may be produced by the accelerometer 520 in response to relatively slow changes in orientation. In other words, a sudden jerk is not required to exceed the threshold acceleration and produce a tilt signal. According to one embodiment, a change in orientation of the signal assembly 520 in the amount of forty-five degrees will produce a tilt signal.

The microprocessor 540 is responsive to the tilt signal produced by the accelerometer 520. In turn, the microprocessor 540 produces an alert signal to the lamp 530. In response to the alert signal, the lamp 530 changes from a stable color (green, for example) to an alert color (red, for example). In this aspect, the microprocessor 540 can be programmed by a user who can choose and select a stable color that will be displayed when the fishing rig 100 is generally at rest in the water. Of course, the fishing rig 100 at rest may be moved about by natural forces, such as the wind or the waves or currents in the water. As used herein, the term “at rest” means the fishing rig 100 is not being moved by a creature such as a fish; the term does not mean stationary.

A user may assemble a significant quantity of fishing rigs 100 to be deployed in a selected body of water, such as a lake. Some users set out 20 or 30 rigs, or more, in a lake and leave them deployed overnight. Other users may also want to deploy their fishing rigs in the same body of water. In this event, different users may want to select different stable colors and alert colors for their particular set of fishing rigs 100. For example, one user may select green to be the stable color, and red to be the alert color, for all his fishing rigs 100. Another user may select white to be her stable color, and flashing blue for the alert color. In this aspect, the fishing rig 100 with programmable microprocessor 540 as described herein facilitates the fishing of a single body of water by multiple users without confusion about which rigs belong to which user.

### Use Case

In use, according to various embodiments, as shown in FIG. 2, the signal assembly 300 is placed within the opening of the float 200 until the disk 400 rests against the opening, and the cap 230 is secured tightly onto the float opening, thereby holding the disk 400 in place.

To activate the programming mode of the signal assembly 300, the user may position the signal assembly 300 in a series of orientations, according to various embodiments. The signal assembly 300 may be placed into programming mode whether it is already inside the float 200 or whether it is being held by the user. For this example, the signal assembly 300 alone may be held and positioned by the user. To activate the programming mode, according to a particular embodiment, the user may execute this series of orientations: (1) placing the signal assembly 300 in a generally horizontal position for two to three seconds, followed promptly by (2) placing the assembly 300 in a generally vertical position with the disk 400 at the upper end and the lamp 530 at the lower end, for two to three seconds, followed promptly by (3) reversing the orientation of the assembly 300 so that the lamp 530 is now on the upper end, for three to six seconds, followed promptly by (4) placing the assembly 300 in a generally horizontal position (again) for about five seconds. In response, the lamp 530 will emit a particular color and pattern (for example, blue and flashing), indicating that the assembly 300 is now in programming mode.

With the signal assembly 300 in programming mode, the user may rotate the assembly 300 about a generally horizontal axis of rotation to select a stable color. (As described herein, the stable color is emitted by the lamp 530 when the fishing rig 100 is actively fishing. The alert color is emitted in response to a tilt signal, indicating there might be fish on the line 110.) According to a particular embodiment, a full rotation is divided into eight sections of forty-five degrees each. As the signal assembly 300, in programming mode, is rotated about its horizontal axis, one of the eight different available LED colors is displayed for each of the eight sections. For example, the lamp 530 may emit a green color in the first section, a yellow color in the next section, and so forth. During the rotation, when the lamp 530 emits the desired color to serve as the stable color, the user may (1) hold the signal assembly 300 in its horizontal position for at least one second, and then promptly (2) place the signal assembly 300 in a vertical position with the disk 400 at the upper end. This action sets the stable color.

When the stable color is set and the signal assembly 300 is still in the vertical position (with the disk 400 at the upper end) the lamp 530 will emit the programming color and pattern again (for example, blue and flashing). This indicates that the assembly 300 is now ready to accept the setting of the alert color. To select the alert color, the signal assembly 300 is placed again in a horizontal position and rotated about its horizontal axis. During the rotation, when the lamp 530 emits the desired color to serve as the alert color, the user may (1) hold the signal assembly 300 in its horizontal position for at least one second, and then promptly (2) place the signal assembly 300 in a vertical position with the disk 400 at the upper end. This action sets the alert color. When the alert color is set and the signal assembly 300 is still in the vertical position (with the disk 400 at the upper end) the lamp 530 will turn off, indicating that programming is completed.

To begin using the fishing rig 100, according to a particular embodiment, the user may hold the float 200 in a cap-down orientation for about five or six seconds. (In the cap-down orientation, the signal assembly 300 inside the float 200 is generally vertical with the disk 400 on the bottom or lower end.) In response, the lamp 530 will emit the stable color and—after waiting about twenty seconds—the fishing rig 100 is ready to be deployed in the water and used for fishing. The lamp 530 will emit the alert color when (and if) a tilt signal is received from the accelerometer 520, as described herein. To stop using the rig 100, the user may hold the float 200 in a cap-up orientation (with the disk 400 on the top or upper end of the signal assembly 300) for about three seconds. In response, the lamp 530 will turn off.

Although several embodiments have been described herein, those of ordinary skill in art, with the benefit of the teachings of this disclosure, will understand and comprehend many other embodiments and modifications for this technology. The invention therefore is not limited to the specific embodiments disclosed or discussed herein, and that may other embodiments and modifications are intended to be included within the scope of the appended claims. Moreover, although specific terms are occasionally used herein, as well as in the claims that follow, such terms are used in a generic and descriptive sense only, and should not be construed as limiting the described invention or the claims that follow.

1. A fishing rig comprising:
a float having a neck portion defining an opening and a selectively releasable cap that is sized and shaped to engage with said opening, said float supporting fishing tackle connected to at least one line; and
a signal assembly comprising:
a disk sized and shaped to be secured between said opening and said cap; and
a panel connected to said disk and supporting a power supply, an accelerometer, and a lamp, wherein said lamp emits an alert in response to a tilt signal produced when said accelerometer detects a movement of said float that exceeds a threshold acceleration.

2. The fishing rig of claim 1, wherein said float comprises a hollow container, said neck portion further defines a plurality of external threads, and said cap comprises a plurality of internal threads sized and shaped to releasably engage said plurality of external threads.

3. The fishing rig of claim 1, wherein said fishing tackle comprises at least one element selected from the group consisting of hooks, lines, leader lines, sinkers, rigs, weights, beads, floats, clevises, swivels, snaps, lures, spinners, and baits.

4. The fishing rig of claim 1, wherein said power supply comprises a battery supported by a battery holder.

5. The fishing rig of claim 1, wherein said lamp comprises a red-green-blue light-emitting diode (LED).

6. The fishing rig of claim 1, wherein said panel is oriented in a direction generally orthogonal with respect to said disk.

7. The fishing rig of claim 1, wherein said panel is positioned inside said float when said disk is secured between said opening and said cap, and wherein said cap provides a generally water-resistant seal.

8. The fishing rig of claim 1, wherein said signal assembly further comprises a programmable microprocessor that is powered by said power supply and electrically connected to said accelerometer and said lamp,
wherein said microprocessor is responsive to said tilt signal produced by said accelerometer in response to said movement,
wherein said microprocessor, in response to said tilt signal, transmits an alert signal to said lamp, and
wherein said alert produced by said lamp comprises a change from a stable color to an alert color.

9. The fishing rig of claim 8, wherein said microprocessor can be programmed by a user to select said stable color to be displayed when said fishing rig is generally at rest in the water, and to select said alert color to be displayed by said lamp in response to said alert signal.

10. The fishing rig of claim 1, wherein said panel comprises a printed circuit board on a generally planar substrate, said substrate having a top face and a generally opposing bottom face,
wherein said printed circuit board electrically connects said power source, said accelerometer, and said lamp, and said microprocessor,
wherein said accelerometer comprises a digital, programmable, three-axis accelerometer, and
wherein said power supply comprises a battery supported on said bottom face by a battery holder.
